(19) United States
(12) Patent Application Publication
(10) Pub. No.: US 2002/0020431 A1
(43) Pub. Date: Feb. 21, 2002

(54) Method and apparatus for removing a mobile ion in a wafer

(76) Inventor: Chin-Hao Chou, Hsinchu (TW)

Correspondence Address: Michael Best & Friedrich LLC, 401 North Michigan Avenue, Chicago, IL, 60611, US

(21) Appl. No.: 09/971,177

(22) Filed: Oct. 4, 2001

Related U.S. Application Data
(62) Division of application No. 09/198,287, filed on Nov. 23, 1998.

(30) Foreign Application Priority Data
May 29, 1998 (TW) 87108487

(51) Int. Cl. B08B 7/00; B08B 3/12; B08B 7/04

(52) U.S. Cl. 134/1.3; 134/1; 134/1.1; 134/1.2; 134/902; 156/345

(57) ABSTRACT

A method and an apparatus are provided for removing a mobile ion in a wafer. The apparatus includes a first inlet for providing a first reactant, a reaction region for generating an active substance with a charge from the first reactant, and a susceptor electrically connected to a voltage for disposing the wafer thereon to attract the active substance to a surface of the wafer and repulsing the mobile ion to the surface of the wafer to enable the mobile ion to react with the active substance to produce a material separable from the wafer.

### FIELD OF THE INVENTION

The present invention is related to a method and an apparatus for removing a mobile ion in a wafer.

### BACKGROUND OF THE INVENTION

In the semiconductor manufacturing process, some mobile ions may be remained in a wafer. Most of the mobile ion are alkali ion, such as sodium ion or potassium ion, existed in the oxide layer of the wafer. The sources of this contamination include the quartz material of the furnace, the used gas, and impurities of the photoresist, etc. Generally, during the silicon oxidation, a suitable amount of hydrogen chloride is added to the reaction gas for removing the alkali ion in the silicon dioxide. However, hydrogen chloride has a strong erosive property so that it is now replaced by chloroform which is mildly erosive and toxic.

It is important to reduce the concentration of alkali ion in the wafer in the modern memory device fabrication to maintain the stability of the wafer. Many methods have been developed for reducing the alkali ion contamination in the semiconductor integrated circuits. For example, U.S. Pat. No. 4,980,301 discloses a method to eliminate the alkali ion concentration by removing a 100 nm thick of a sacrificial oxide layer; U.S. Pat. No. 4,679,308 provides a method of using a getting agent on the surface of photoresist. Currently, the photoresist removal process is one of the most commonly used methods to remove the high-level residues of alkali ions. The standard photoresist removal process includes the steps of (1) forming an oxide 2 on a silicon substrate 1 of the wafer, (2) forming a photoresist 3 on the oxide 2 and patterning the photoresist 3 by photolithography to etch a portion of the oxide, and (3) removing the photoresist 3 and performing the plasma ashing process and wet solvent cleaning process to remove the alkali ion as shown in FIGS. 1(a)˜(d). However, this standard photoresist removal process could not effectively remove the alkali ion on the wafer surface. It is found that about 1E17˜1E19 cm⁻³ of the alkali ion would be left on the wafer surface after performing the photoresist removal process (J. Chinn, et al. Built-in reliability through sodium elimination (1994) IRPS p. 249). Therefore, the present invention provides a plasma downstream processing method to effectively remove the mobile ion in the wafer. This type of downstream reaction have been reported for removing a native oxide film via hydrogen radical process (e.g. U.S. Pat. No. 5,620,559). In addition, U.S. Pat. Nos. 5,562,775 and 5,105761 also disclosed that the plasma downstream processing method can provide less damage and high processing speed for chemical etching and deposition. Thus, the method of the present invention can prevent the electron charge-up on the wafer surface and trap the alkali ion from photoresist.

### SUMMARY OF THE INVENTION

An object of the present invention is to provide a method for removing a mobile ion in a wafer. The method includes the steps of providing an active substance with a charge and providing a voltage to the wafer for attracting the active substance to a surface of the wafer and repulsing the mobile ion to the surface of the wafer to enable the mobile ion to react with the active substance to produce a material separable from the wafer.

The mobile ion is one selected from a group consisting of alkali ions, for example, sodium ion and potassium ion.

In one preferred embodiment, the active substance is a negative radical, such as OH⁻and HO₂⁻. The wafer is electrically connected to a positive bias voltage for attracting the negative radical to the surface of the wafer and repulsing the alkali ion to the surface of the wafer to enable the negative radical to react with the alkali ion to produce the material separable from the wafer.

Another object of the present invention is to provide an apparatus for removing a mobile ion in a wafer.

In accordance with the present invention, the apparatus includes a first inlet for providing a first reactant, a reaction region for generating an active substance with a charge from the first reactant, and a susceptor electrically connected to a voltage for disposing the wafer thereon to attract the active substance to a surface of the wafer and repulsing the mobile ion to the surface of the wafer to enable the mobile ion to react with the active substance to produce a material separable from the wafer.

Preferably, the first reactant is one selected from a group consisting of hydrogen and a mixture of hydrogen and argon.

Preferably, the reaction region includes a plasma generator for generating a plasma of the first reactant.

The apparatus further includes a second inlet for providing a second reactant. The second reactant is one selected from a group consisting of oxygen, nitrogen dioxide, and a mixture thereof. The second reactant reacts with the plasma of the first reactant to generate a negative radical, e.g., OH⁻and HO₂⁻. Preferably, the wafer is electrically connected to a positive bias voltage for attracting the negative radical to the surface of the wafer and repulsing the alkali ion to the surface of the wafer to enable the negative radical to react with the alkali ion to produce a volatile material separable from the wafer. The positive bias voltage is preferably ranged from +200V to +300V. The apparatus further includes a heater to be disposed at a bottom of the susceptor for dispersing the volatile material.

Preferably, the second inlet is disposed at a downstream region of the reaction region to construct a secondary reactor and the susceptor is disposed at a downstream region of the second inlet. Certainly, the distance between the second inlet and the susceptor can be optionally adjusted.

The present invention may best be understood through the following description with reference to the accompanying drawings, in which:

### BRIEF DESCRIPTION OF THE DRAWINGS

FIGS. 1(a)˜(d) are schematic diagrams showing a standard photoresist removal process of the prior art;

FIG. 2 is a schematic diagram showing a preferred embodiment of the apparatus for removing a mobile ion in a wafer according to the present invention; and

FIG. 3 is a schematic diagram showing a preferred embodiment of the method for removing a mobile ion in a wafer according to the present invention.

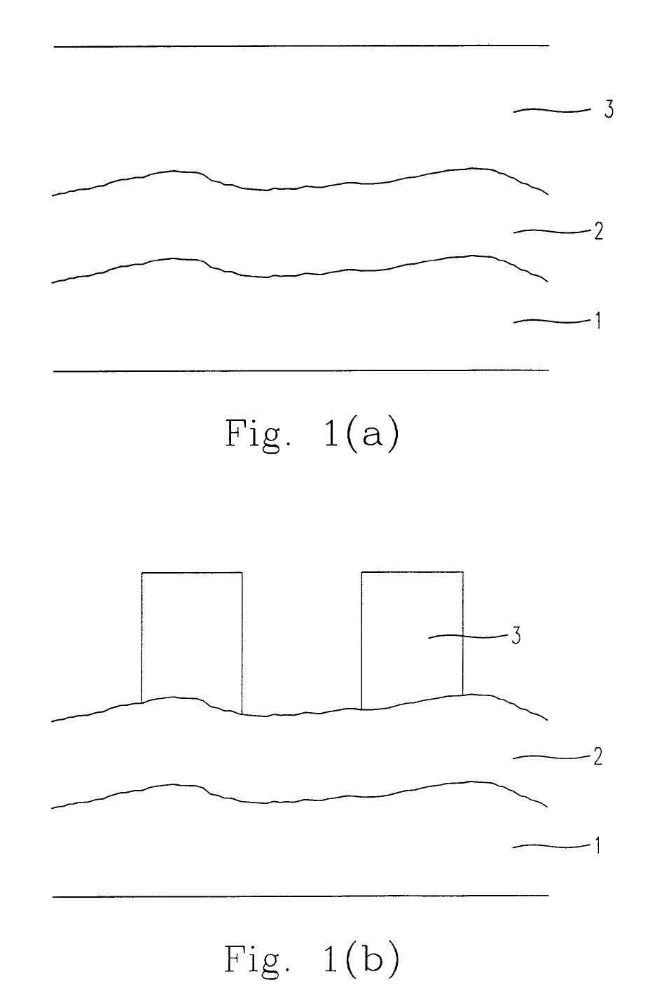

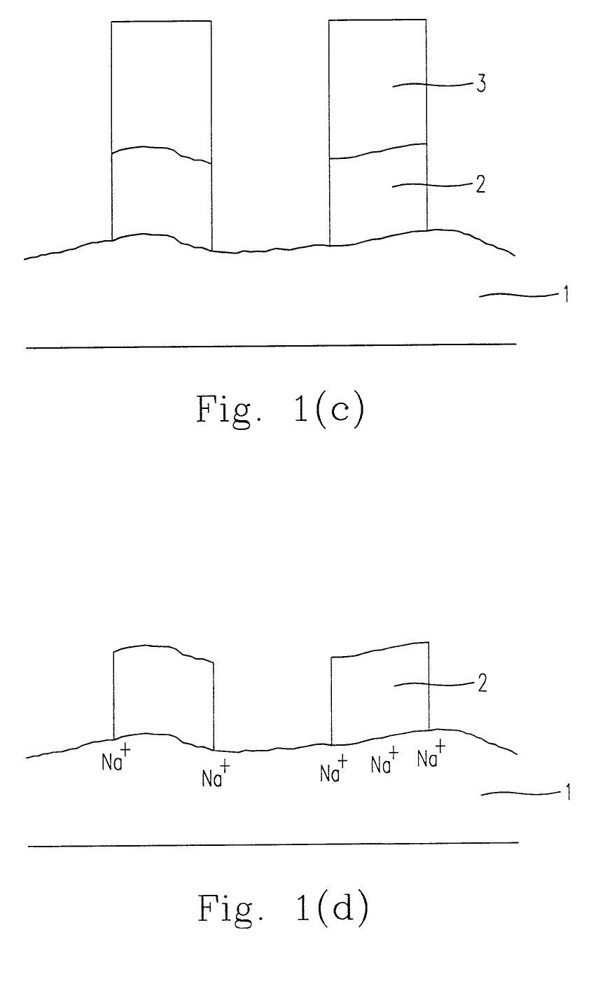

### DETAILED DESCRIPTION OF THE PREFERRED EMBODIMENT

The present invention will now be described more detailedly with reference to the following embodiments. It is to be noted that the following descriptions of the preferred embodiments of this invention are presented herein for the purpose of illustration and description only. It is not intended to be exhaustive or to be limited to the precise form disclosed.

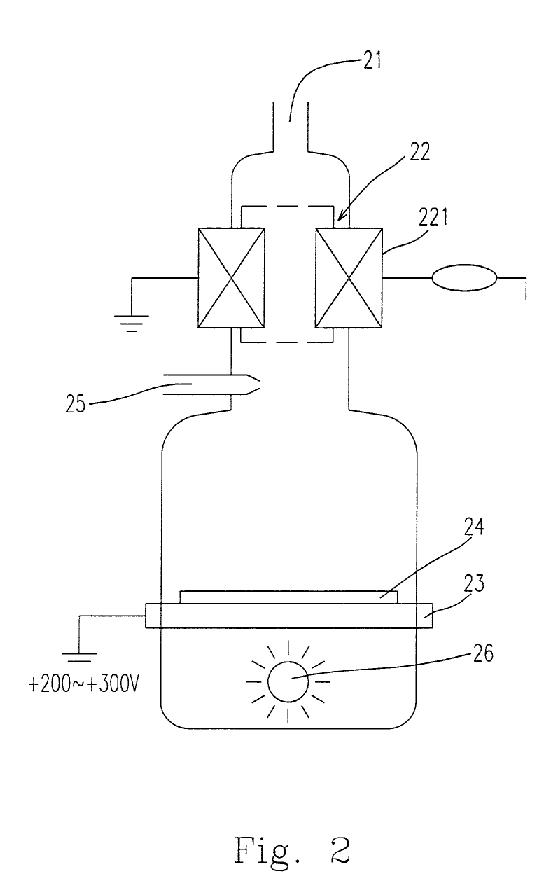

In the semiconductor manufacturing process, the present invention provides a method and an apparatus for removing a mobile ion in a wafer. The apparatus of the present invention is shown in FIG. 2. The apparatus includes a first inlet 21 for providing a first reactant, a reaction region 22 for generating an active substance with a charge from the first reactant, and a susceptor 23 electrically connected to a voltage for disposing the wafer thereon.

The first reactant is preferably hydrogen or a mixed gas of hydrogen and argon. The reaction region 22 includes a plasma generator 221 for generating a plasma of hydrogen or the mixed gas of hydrogen and argon.

The apparatus further includes a second inlet 25 for providing a second reactant. The second reactant can be oxygen, nitrogen dioxide, or a mixture thereof. The second inlet 25 is disposed at a downstream region of the reaction region 22 to construct a secondary reactor. The susceptor 23 is disposed at a downstream region of the second inlet 25. Certainly, the distance between the second inlet 25 and the susceptor 23 can be optionally adjusted.

The wafer 24 is put on the wafer susceptor 23 disposed at the downstream region of the injection point. The second reactant such as oxygen or NO₂ is injected at the downstream region of the plasma generator 221. The second reactant reacts with the plasma of the hydrogen or a mixed gas of hydrogen and argon to generate a negative radical, e.g., OH⁻and HO₂⁻.

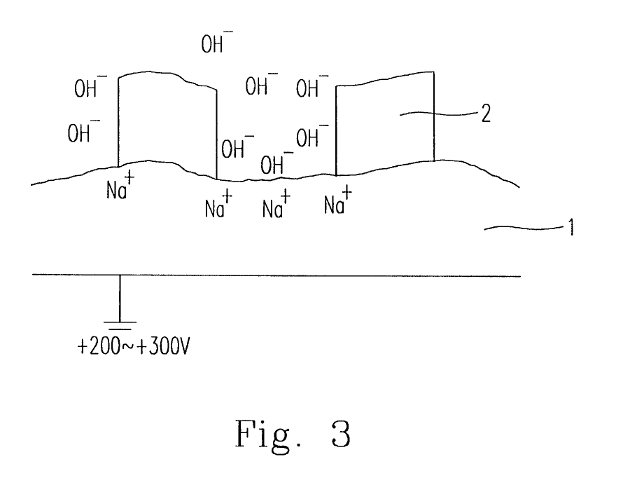

As we know, most of the mobile ions are alkali ions, for instance, sodium ion or potassium ion. In order to facilitate the neutralization, the wafer 24 may be electrically connected to a positive bias voltage for attracting the negative radical (e.g. OH⁻) to the surface of the wafer and repulsing the alkali ion (e.g. Na⁺) to the surface of the wafer to enable the negative radical to react with the alkali ion to produce a volatile material (e.g. gaseous NaOH) separable from the wafer as shown in FIG. 3. The positive bias voltage is preferably ranged from +200V to +300V. This type of active radicals can act as a reducing agent to remove the alkali ions. The apparatus further includes a heater to be disposed at a bottom of the susceptor 23 for dispersing the volatile material. This method can dramatically reduce the concentration level of the alkali ion in the wafer.

In conclusion, the present invention provides a simple method and an apparatus which can significantly reduce the mobile ion (alkali ion) contamination on the wafer. This kind of the secondary afterglow reactor can be used to generate the active radicals via a plasma and molecular reaction for significantly reducing the alkali ion concentration on the wafer surface. The generated radicals such as HO₂⁻and OH⁻can highly react with alkali ions to form a volatile species. The purpose of this cleaning process is to remove the alkali ion residued on the wafer surface and to obtain the lower surface concentration of alkali ion.

In addition, the downstream plasma processing method can prevent the electron charge-up on the wafer surface and trap the alkali ion from photoresist.

While the invention has been described in terms of what are presently considered to be the most practical and preferred embodiments, it is to be understood that the invention need not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A method for removing a mobile ion in a wafer comprising:
providing an active substance with a charge; and
providing a voltage to said wafer for attracting said active substance to a surface of said wafer and repulsing said mobile ion to said surface of said wafer to enable said mobile ion to react with said active substance to produce a material separable from said wafer.

2. A method according to claim 1 wherein said mobile ion is one selected from a group consisting of alkali ions.

3. A method according to claim 2 wherein said mobile ion is one of sodium ion and potassium ion.

4. A method according to claim 2 wherein said active substance is a negative radical.

5. A method according to claim 4 wherein said negative radical is one of OH⁻and HO₂⁻.

6. A method according to claim 4 wherein said wafer is electrically connected to a positive bias voltage for attracting said negative radical to said surface of said wafer and repulsing said alkali ion to said surface of said wafer to enable said negative radical to react with said alkali ion to produce said material separable from said wafer.

7. An apparatus for removing a mobile ion in a wafer, comprising:
a first inlet for providing a first reactant;
a reaction region for generating an active substance with a charge from said first reactant; and
a susceptor electrically connected to a voltage for disposing said wafer thereon to attract said active substance to a surface of said wafer and repulsing said mobile ion to said surface of said wafer to enable said mobile ion to react with said active substance to produce a material separable from said wafer.

8. An apparatus according to claim 7 wherein said mobile ion is one selected from a group consisting of alkali ions.

9. An apparatus according to claim 8 wherein said first reactant is one selected from a group consisting of hydrogen and a mixture of hydrogen and argon.

10. An apparatus according to claim 9 wherein said reaction region includes a plasma generator for generating a plasma of said first reactant.

11. An apparatus according to claim 10 further comprising a second inlet for providing a second reactant.

12. An apparatus according to claim 11 wherein said second reactant is one selected from a group consisting of oxygen, nitrogen dioxide, and a mixture thereof.

13. An apparatus according to claim 111 wherein said second reactant reacts with said plasma of said first reactant to generate a negative radical.

14. An apparatus according to claim 13 wherein said negative radical is one of OH⁻and HO₂⁻.

15. An apparatus according to claim 14 wherein said wafer is electrically connected to a positive bias voltage for attracting said negative radical to said surface of said wafer and repulsing said alkali ion to said surface of said wafer to enable said negative radical to react with said alkali ion to produce a volatile material separable from said wafer.

16. An apparatus according to claim 15 further comprising a heater to be disposed at a bottom of said susceptor for dispersing said volatile material.

17. An apparatus according to claim 15 wherein said positive bias voltage is ranged from +200V to +300V.

18. An apparatus according to claim 10 wherein said second inlet is disposed at a downstream region of said reaction region to construct a secondary reactor.

19. An apparatus according to claim 10 wherein said susceptor is disposed at a downstream region of said second inlet, and a distance between said second inlet and said susceptor is optionally adjusted.
